(19) United States
(12) Patent Application Publication
(10) Pub. No.: US 2026/0348087 A1
(43) Pub. Date: Nov. 5, 2026

(54) PRINTED FABRIC

(71) Applicant: Kornit Digital Ltd., Rosh HaAyin (IL)

(72) Inventors: Lavit FELDMAN, ShaAr Effraim (IL); Jacob MANN, Zoran (IL); Ira YUDOVIN-FARBER, Rehovot (IL); Lior IAGHER, Ramat Gan (IL); Eliyahu SHMOELI, Petah Tikva (IL); Dor WEINBERGER, Herut (IL)

(73) Assignee: Kornit Digital Ltd., Rosh HaAyin (IL)

(21) Appl. No.: 19/117,975

(22) PCT Filed: Sep. 26, 2023
(86) PCT No.: PCT/IL2023/051034

§ 371 Date: Apr. 3, 2025

Related U.S. Application Data
(60) Provisional application No. 63/412,593, filed on Oct. 3, 2022.

(51) Int. Cl. D06N 3/00; B32B 5/02; B32B 27/12; B32B 27/40; B32B 37/24; B32B 37/26; D04H 1/4258; D04H 1/4334; D04H 1/4382; D04H 1/732; D06N 3/14

(52) U.S. Cl. CPC D06N 3/004; B32B 5/022; B32B 27/12; B32B 27/40; B32B 37/24; B32B 37/26; D04H 1/4258; D04H 1/4334; D04H 1/43835; D04H 1/732; D06N 3/14; B32B 2037/243; B32B 2037/268; B32B 2250/40; B32B 2262/0261; B32B 2262/04; B32B 2262/144; B32B 2305/28; B32B 2307/542; B32B 2317/18; B32B 2375/00; B32B 2377/00; B32B 2451/00; D06N 2201/0263; D06N 2201/042; D06N 2211/12

(57) ABSTRACT

A process and an apparatus for forming a fabric with multiple elastomer layers and flocking layers using digital printing methodology is disclosed. The process involves applying a release layer on a surface, flocking the release layer, printing elastomer ink compositions, flocking the elastomer layers, curing/drying the fabric, and releasing the fabric from the surface. The apparatus for forming the fabric comprises a surface with a release layer, a flocking station, a digital printing station, and a curing/drying device. The disclosed process allows for the formation of fabrics with multiple elastomer layers and flocking layers, which can provide improved properties such as hand-feel, durability, flexibility, and aesthetics, and can therefore be useful for a variety of applications, such as the manufacture of apparel, footwear, and other personal accessories.

### RELATED APPLICATION/S

This application claims the benefit of priority under 35 USC § 119 (e) of U.S. Provisional Patent Application No. 63/412,593, filed 3 Oct. 2022, the contents of which are incorporated herein by reference in their entirety.

### FIELD AND BACKGROUND OF THE INVENTION

The present invention, in some embodiments thereof, relates to digital printing and more particularly, but not exclusively, to a process of digitally forming a two-sided flocked synthetic fabric.

Fabrics have been made and used by humans for millennia, with very little change to the rudimentary fabrication process. With the advent of synthetic polymers, natural fibers from plants and animals have been supplemented or replaced with synthetic fibers, revolutionizing the field of textile, but making only a small impact on the fabric formation process. Polymers have also been used to make thin films and sheets, resembling the overall shape of a piece of fabric, however, the texture and mechanical properties of “plastic sheets” could not come close to those of fiber-based fabrics. Non-woven fiber-based fabrics further bridged the gap between plastic sheets and woven fabrics.

Creation of flat and flexible non-woven objects having the shape and some of the characteristics of a synthetic fabric have been known for decades, and in most cases, the basic fabrics are created by several long and intermittent processes with many steps and means, and typically carried out at several few locations. The end products (finished fabrics, garments, wearable, or decoration items) are further processes from the raw materials in yet another location. The standard fabric creation processes are long, pollutant and use a lot of energy and water. The fabrics are created in advance and then requires a complex logistic chain, such as storage, shipment to the next manufacturing stage (sewing, printing), etc., which becomes the most expensive component of the fabric lifecycle.

Creating fabric and/or garment synthetically from a base layer and double-sided coating is a complex process with manual intervention. The end result needs to meet the basic criteria of a fabric, such as flexibility, strength, breathability, durability, hand-feel, texture, etc. To coat two sides of the fabric, each side is glued, coated, and cured/dried separately so the process has multiple stages that each is carried out independently. The analog nature of the process requires mechanical preparations (predefined mold) for each fabric and/or garment type (size, width, etc.) and the overall accuracy of the process, such as its width, length, and thickness of the fabric, is determined by the mechanical aspects (usually limited a few millimeters or even centimeters).

The glue layer needs to be synchronized with the base fabric; when the base surface has a pattern with holes or cavities, there is a need to screen the glue, to avoid blocking the holes with glue that leads to flock fiber blocking, and loss of desired fabric properties, such as breathability, hand-feel, and texture.

Flocking is the process of depositing many small fiber particles (called flock) onto a surface. It can also refer to the texture produced by the process, or to any material used primarily for its flocked surface. Flocking is used in many ways to give a surface a texture like velvet, velveteen, or velour, such as t-shirts, wallpaper, gift/jewelry boxes, and upholstery. Besides the application of velvety coatings to surfaces and objects, flocking in fabrics is a method of creating another surface.

During flocking, fibers or a layer of flocks are deposited over a substrate and affixed to the surface of the substrate with an adhesive, which is applied over the entire or over specific area(s) of the surface. In most cases, the fibers are attached to the adhesive by the well-known methods: transfer from flocking paper by heat press, application of a high-voltage electric field, or even by simply pouring the fibers on top of the adhesive layer.

In current standard implementations, the adhesive is applied on the surface by spreading it with simple mechanical means, such as roller, brush, pad, spray, etc.; in the screen-printing industry the adhesive layer can be applied by a mesh, as an additional layer on the surface; another, more flexible method is based on glue-sheets, where the desired image is first created on a sheet covered with glue, then transferred to the substrate by heat press, and finally the flocks are applied only to the glued areas to create flocking of the image, or an image made of flock. In all these cases, the result is usually a single coated area; or in more complex applications, a few relatively large areas, with an inaccurate and a single layer of the adhesive, and therefore, the resulting product is a single and uniform layer of flocks coating.

The current standard implementations are based on “analog” and rough application of the adhesive that attaches the flocks to the surface. The resulting pattern or image is therefore inaccurate, and has the same flocking characteristics all over its flocked area(s)—including color or shade, hand-feel, appearance, density, etc., and in addition, the processes are not suitable for mass production since they involve complex and manual operations with multiple stages.

BE 526940A provides clothing comprising between the outer fabric and the lining a fabric insert which is provided, for the purpose of imparting modified shapes, for example rounded shapes, to the clothing, in the appropriate places, with coverings or veneers and the shape of which is modified in the desired direction by cutouts at an acute angle, the sides of which are brought together and assembled (clamps), characterized in that the aforesaid coverings consist of a non-woven, porous, isoelastic and stable in the diagonal direction, i.e. in a thin fibrous web, the fibers of which extend essentially in intersecting directions and are fixedly joined to each other, at their points of contact or crossing, by flexible adhesive agents and elastic, such as vulcanized rubber and/or artificial rubber, while between the fibers are provided a large number of advantageously flat and relatively large pores, which extend essentially in planes extending parallel to the main plane of the web of fibers, the parts of the fibers between the places where they are in contact with each other being free of adhesive agent or having only small amounts of adhesive agent, in a porous and moisture-permeable form.

U.S. Pat. No. 2,691,611A provides a process of producing an article with inner and outer piles of flock fibers protruding from an adhesive comprising depositing of a primary adhesive on a mold form, electrostatically embedding one end of flock fibers of a predetermined length in the primary adhesive, depositing a secondary adhesive between the fibers on and in contact with the primary adhesive and building up said deposit between the fibers to a predetermined thickness with the end portion of the fibers protruding from the secondary adhesive being uncovered and exposed, stripping the article from the mold form and removing the primary adhesive to expose the ends of the fibers which have been embedded.

U.S. Pat. No. 2,951,005A provides a method of forming a stretchable sheet material which comprises applying an adhesive to one surface of a permeable fibrous web of elastomeric fibers in random distribution and bonded together at their points of contact, stretching the fibrous web to open the interstices in at least the surface portion of the fibrous web and prevent blocking of the interstices by the adhesive, applying flocked fibers to the adhesive coated surface, curing the adhesive, securing a non-elastomeric, expansible textile fabric to the opposite surface of the fibrous web and allowing the fibrous web to relax whereby the flocked fibers form an uninterrupted napped surface coextensive with the web.

U.S. Pat. No. 3,232,819A provides breathable structures, and a sheet metal having front and rear major faces comprising an accretion of randomly arranged overlapping, intersection and interfitting solid filamentous strands having lengths predominately in the range of 200 to 2500 microns and diameters predominately 10 microns and less, and irregularly shaped nodular particles, both strands and particles, comprising normally solid polymer, being coalesced into a unified air-permeable structure wherein the rear face has the general appearance of the flesh side of tanned leather with an uneven lacy surface.

U.S. Pat. No. 3,585,099A provides a plastic sheet material having a textured, granular, relief surface is made, without necessity for resorting to surface molding or embossing to provide the relief effects, by partially embedding vinyl resin granules in the surface of a vinyl plastisol base layer; contoured automobile mats, or flat sheet goods with or without a textile or other reinforcing backing, may be made by the method; flock may be applied to the surface of the granules to give textile like effects.

U.S. Pat. No. 3,922,455A provides linear elements such as filaments having grafted nibs, which are generally fibrils and/or scales which can be flexible or rigid. The nibs can be randomly grafted onto the linear element or they can be inclined or oriented in one direction so as to offer relatively little resistance to penetration into a material and greater resistance to pulling out. The linear element with grafted nibs or a yarn thereof can be used as a nonslip thread, as laces, and the like or they can be a component of woven and non-woven articles.

GB 856389A provides a process for manufacturing impregnated woven or non-woven fibrous sheet material consists in applying an impregnant in the form of a foam on to one surface of a fibrous sheet material and in applying suction to the opposite surface of the sheet to suck the impregnant into the sheet.

CA 1172001A provides interlining of garments and method for the manufacture thereof, for stiffening parts of garments such as collars, cuffs sleeves shoulders and similar parts of outer garments. The interlinings are particularly intended for iron-on or sewn patches and comprise; an interlining backing material consisting of a fabric which may be woven, textile or knitted, or a fleece, or simply a plurality of fibers arranged side by side; textile flock fibers having a fiber length of 005 to 2.0 mm and a flock binder consisting at least in part of a polymer material which is applied to the backing material in the form of a screen like imprint. The screen like imprint may consist of a screen of dots, lines or small rods numbering from 140 to 700 per square inch. The flock binder includes micro dispersed filling materials fast to cleaning and abrasion resistant. The flocks are applied to the flock binder by an electro-static force field of direct current with a voltage within the range 20 to 100 KV.

### SUMMARY OF THE INVENTION

The present invention provides a process for generating fabrics using digital inkjet or other digital printing methodologies.

The present invention provides a multilayered fabric that is made up of a bottom flock layer of small fibers which have been pre-disposed on a transient release layer, and further made up of one or more elastomer layers, and a top flock layer of the same or different flock fibers. The fabric has a variety of structural and composition properties, such as a soft, fuzzy surface, decorative and functional features, durability, water resistance, stain resistance, mildew resistance, and odor resistance.

An exemplary process for producing a fabric may include, according to some embodiments:
Providing a support substrate having a transient release layer applied thereon (the release layer composition can be applied each time or it can be reusable for more than one print-job);
Apply flocks on the release layer;
Inkjet printing at least 2 layers of an elastomer (optionally forming a colored image);
Partially curing/drying the elastomer by IR, UV and/or hot air (optionally at the same time of the inkjet printing);
Inkjet printing at least two additional layers of elastomer (optionally using different pattern and/or color and/or elastomer material, and/or add hardware items);
Partially curing/drying the elastomer (optionally at the same time of the printing);
Apply flocks on the top elastomer layer (optionally controlled by top elastomer layer to create tunable coating);
Cure/dry;
Releasing the printed fabric.

The present invention provides an apparatus to carry out the process for generating fabrics using digital inkjet deposition or printing methodologies. An exemplary apparatus for producing a fabric may include, according to some embodiments:
A support platform/substrate (optionally in the form of a loop belt);
Optional means for depositing the release layer (can be digital jet-valves, or analog spray, bar coater, blades etc.);
A first flocking station;
An elastomer digital printing station (optionally multi-color);
An in-line mean for curing/drying in communication with the inkjet printing station by IR, UV and/or hot air (optionally embedded in the inkjet station);
An optional in-line means to pick and place prefabricated items within the printed elastomer layers;
A second flocking station (optional as the first flocking station can be used for this purpose);
A curing station by IR and/or hot air; and
An optional roller to roll printed fabric or a plate to collect the printed pieces.

Thus, according to an aspect of some embodiments of the present invention, there is provided a process of forming a fabric, which is carried out by:
i. applying a release layer on a surface, wherein the release layer acts as a temporary mean for holding the flocks before an adhesive elastomer ink composition is applied thereon;
ii. flocking the release layer using a first flock material to afford a bottom flock layer;
iii. printing a first elastomer ink composition on said bottom flock layer to afford a first elastomer layer, wherein the elastomer ink composition also acts as an adhesive for the bottom flock layer;
iv. partially curing/drying the first elastomer layer, optionally during the printing process, to afford a stabilized elastomer layer, wherein the stabilization allows to apply additional layers that form the base layer of the fabric as well as 3D elements thereon;
V. printing the first elastomer ink composition or a second elastomer ink composition on the stabilized elastomer layer to afford a second elastomer layer, wherein the first and second elastomer ink compositions can be identical, similar or different in composition, color, pattern and coverage area;
vi. flocking the second elastomer layer using the first flock material or a second flock material to afford a top flock layer, wherein the top flock layer can be uniform, gradual (greyscale) and/or pattered;
vii. curing/drying the fabric, wherein this step sets the fabric in its final layered structure; and
viii. releasing the fabric from the surface, wherein this step may also include cleaning the fabric from excess untethered flocks, thereby affording the fabric, wherein the surface on which the fabric is formed is devoid of a rim, a shoulder or any form of a raise boundary (the surface is flat; neither a mold nor a former is used in the process).

In some embodiments, the release layer composition includes a substance having a viscosity of 100-100,000 centipoises at a temperature of 25 °C.

In some embodiments, the substance in the release layer composition is selected from the group consisting of an aqueous polymer solution, a hydrogel, and a silicone-based substance

In some embodiments, all printing steps are effected digitally. In some embodiments, all inks are printed digitally, and the immobilizing composition is applied by printing or spraying.

In some embodiments, the elastomer ink composition is printed essentially together with an immobilization composition.

According to some embodiments of the present invention, the process further includes repeating steps iii-v n times to afford an n^{th} elastomer layer, wherein n is an integer; and the elastomer ink composition is an n^{th} elastomer ink composition, which may be the same elastomer ink composition or a different elastomer ink composition compared to any one of the elastomer ink compositions used to form any one of the previous elastomer layers. In other words, each elastomeric layer may have a different chemical composition, and thus different mechanical properties.

In general, each elastomer ink layer can be identical, similar or different than the other elastomer ink layer, and the difference can be in any one of the following: elastomer type/concentration/formulation, colorant, area/pattern of coverage (each layer can be printed according to a different raster image processor (RIP) set of commands), partial drying parameters such as temperature, duration, the ingredients and the deposited amount of the immobilization composition. Adding layers on top of each other forms the base layer of the fabric as well as various 3D features thereon.

According to some embodiments of the present invention, each of the first elastomer ink composition, the second elastomer ink composition and/or the n^{th} elastomer ink composition is individually colored.

According to some embodiments of the present invention, each of the first elastomer ink composition, the second elastomer ink composition and/or the n^{th} elastomer ink composition is individually printed on the same or difference area.

According to some embodiments of the present invention, at least one of the digitally printing is effected with an immobilizing composition. The immobilizing composition is applied using a designated print channel and applicator (printhead or spray nozzle); the immobilizing composition can be applied before, during and/or subsequent to printing the elastomer ink composition, such that the elastomer ink composition coagulates upon contacting the immobilizing composition.

According to some embodiments, the surface is a moving or a stationary printing pallet, a conveyer belt, or a plate.

According to some embodiments, the release layer is in a form of a gel.

According to some embodiments, the release layer is for a single use, for multiple-use or for continuous mode use.

According to some embodiments, the process further includes placing at least one preformed object on or in the elastomer layer.

In some embodiments, the preformed object is selected from the group consisting of a zipper, a button, a button loop, a tack, a hook-and-loop fastener, an electronic circuit, an RFID tag, and a thermal glued strip.

According to some embodiments, the process further includes, subsequent to step vi, heat pressing the top flock layer.

According to some embodiments, the process further includes, prior to step vii, printing a colored ink composition on the top flock layer.

According to some embodiments, the process further includes cleaning the fabric from excess flock fibers.

According to some embodiments, the process further includes, rolling the fabric on a roller. According to some embodiments, the process further includes, collecting the fabric piece on a plate.

According to another aspect of some embodiments of the present invention, there is provided an apparatus for executing the process provided herein and forming the fabric, according to some embodiments of the present invention; the apparatus includes:
a surface in the form of a moving or a stationary printing pallet, a conveyer belt, or a plate, having a release layer applied thereon;
a first flocking station;
a digital printing station; and
a curing/drying device,
wherein the surface on which the fabric is formed is devoid of a rim, a shoulder or any form of a raise boundary (the surface is flat; neither a mold nor a former is used in the apparatus).

In some embodiments, the apparatus further includes a second flocking station downstream of the digital printing station.

In some embodiments, the apparatus further includes a heat-press station downstream of the second flocking station.

In some embodiments, the apparatus further includes a release layer applicator for applying the release layer on the surface.

In some embodiments, the digital printing station includes means for applying at least one elastomer ink composition.

In some embodiments, the digital printing station includes means for applying an immobilizing composition.

In some embodiments, the apparatus further includes a roller or a plate for collecting the fabric.

In some embodiments, the apparatus further includes a plate for collecting the fabric pieces.

In some embodiments, the apparatus further includes means for adding hardware items to the fabric.

In some embodiments, the apparatus further includes means for partial curing/drying before, after, or during printing.

According to another aspect of some embodiments of the present invention, there is provided a multi-layered fabric that includes a bottom flock layer, at least one elastomer layer, and a top flock layer, wherein the bottom layer is releasably attached to a release layer.

According to another aspect of some embodiments of the present invention, there is provided a multi-layered fabric that includes a bottom flock layer, at least one elastomer layer, and a top flock layer, wherein the bottom flock layer includes at least a trace amount of at least one ingredient of the release layer composition.

In some embodiments, the trace amount constitutes less than 1% by weight of the total weight of the fabric.

In some embodiments, the further includes a support substrate releasably attached to the fabric via a release layer.

In some embodiments, the further includes at least one preformed object incorporated therein.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF SEVERAL VIEWS OF THE DRAWINGS

Some embodiments of the invention are herein described, by way of example only, with reference to the accompanying figures. With specific reference now to the figures in detail, it is stressed that the particulars shown are by way of example and for purposes of illustrative discussion of embodiments of the invention. In this regard, the description taken with the figures makes apparent to those skilled in the art how embodiments of the invention may be practiced.

In the figures:

FIGS. 1A-B present: (A) an illustration the exemplary embodiment presented above, wherein on the left side the process is presented as a flowchart, and on the right side the outcome of each step is depicted as a side view of the emerging fabric, and (B) a side-view illustration of a fabric created according to some embodiments of the present invention, having particular areas with specific physical attributes;

FIG. 2 presents a side-view illustration of a part of an apparatus for continuous printing process of a fabric, according to embodiments of the present invention, showing that the entire process can be performed on a conveyer belt with the functional modules positioned along its path, wherein the fabric is created step by step until finally rolled as a final product;

FIG. 3 presents a top-view illustration of an apparatus for continuous printing process of a fabric, according to embodiments of the present invention, showing different modules, their functionality, and their optional configurations, wherein the fabric is created step by step until finally rolled as a final product; and

FIGS. 4A-C present: (A) black and white photographs of lace-like fabrics produced according to some embodiments of the present invention, showing lace with stitch effect, (B) a lace garment with reinforced edges around holes, and (C) lace pieces with variable coating thereon.

### DESCRIPTION OF SOME SPECIFIC EMBODIMENTS OF THE INVENTION

The present invention, in some embodiments thereof, relates to digital printing and more particularly, but not exclusively, to a process of digitally forming a two-sided flocked synthetic fabric.

The principles and operation of the present invention may be better understood with reference to the figures and accompanying descriptions.

Before explaining at least one embodiment of the invention in detail, it is to be understood that the invention is not necessarily limited in its application to the details set forth in the following description or exemplified by the Examples. The invention is capable of other embodiments or of being practiced or carried out in various ways.

As known in the art, basic synthetic fabrics are created by a long process with many steps and means conducted in several locations. The end products (finished garments, wearable, or decoration items) are then cut and sewed from the raw materials in yet another location. Known fabric creation processes are long, pollutant and use a lot of energy and water. The fabrics are created in advance and then requires a complex logistic chain, such as storage, shipment to the next manufacturing stage (sewing, printing), etc., which becomes a very costly component in the fabric lifecycle.

Creating fabric synthetically from a base layer and double-sided coating is a complex process with manual intervention. The end result needs to meet the basic criteria of a fabric, such as flexibility, strength, breathability, durability, hand-feel, texture, etc. To coat two sides of the fabric, each side is glued, coated, and cured/dried separately so the process has multiple stages that each is carried out independently. The analog nature of these processes requires mechanical preparations (predefined mold or former) for each fabric type (size, width, etc.) and the overall accuracy of the process is determined by the mechanical aspects (usually limited a few millimeters or even centimeters). In addition, the adhesive (glue) layer needs to be synchronized with the base fabric; when the base surface has a pattern with holes or cavities, there is a need to screen the glue, to avoid blocking the holes with glue that leads to flock fiber blocking.

The present invention provides a single flow process for the full digital creation of a fabric, starting with raw materials (e.g., elastomeric inks and flocks) and ending with the final product with specific physical attributes based on industry standards, and visual appearance of a fabric.

The present invention provides a single flow process for creation of a base material (“base layer”) to achieve the required physical attributes with high accuracy in multiple areas (e.g., flexibility, strength, breathability, lightness, etc.).

The present invention provides a single flow process to afford double sided coating of a base layer.

The presently provided process can be performed on a single printing machine, such as Kornit's systems, equipped with the required additions, such as flocking, partial curing and/or drying. In the context of the present invention, the terms “curing” and “drying” are generally used interchangeably, unless otherwise is stated. The two terms may refer to two different processes. Curing is the process by which the ink is chemically cross-linked to form a solid film, which is usually done by exposing the ink to ultraviolet (UV) light or heat. Drying is the process by which the solvent in the ink evaporates, leaving behind the pigment and binder. Drying is usually done by simply exposing the ink to air, but it can also be accelerated by using heat or fans. Drying, and particularly drying under elevated temperatures, such as 100-180 °C, may also initiate cross-linking.

The curing and/or drying process needs to be accurate and efficient to support the complete process, therefore the conjugation of all components of the system is not merely a spatial conjugation but also a process controller conjugation, wherein machine commands link and coordinate the various stages of the process.

The process provided herein, based on a designated apparatus (printing machine) is based on principles of digital inkjet printing, allowing high resolution and accuracy and full digital control over the entire process.

For example:
Selective locations for flocking at a placement accuracy of less than 100 microns;
Selective width of the base (elastomeric) layer with accuracy of less than 10 microns;
Selective density of flocking by specific patterns of the product, resulting a different hand feel, etc. (variable, greyscale flocking);
Use of inkjet digital ink as adhesive material, allowing changing the flocking characteristics at any location on the product;
Changing the color of the background (base layer) of the product by any combination of inks.

Table 1 compares the methods known in the art to the process provided herein.

TABLE 1

| Characteristic | Prior art | Present invention |
|---|---|---|
| Fluid deposition | Analog; | Digital print. |
| | Spray, continuous, area-level | Drop-on-demand, pixel-level coverage |
| | coverage | |
| 3D formation | Pre-manufactured mechanical | On the fly; |
| | mold, former | Defined by number of layers and/or |
| | | drop volume in each area; contains |
| | | built-in and in-line partial curing |
| Mesh formation | Limited by mold pattern and | Any pattern, not limited, including |
| | mechanical manufacturing | continuous roll of fabric (R2R) |
| Multi-layer | No, single path | Unlimited number of layers optionally |
| | | by immobilization on the fly and/or |
| | | partial curing for stable structure |
| Product | Predefined and fixed by the mold | Unlimited; defined on-the-fly by |
| thickness | | number of layers and/or drop size for |
| | | each area; product can exhibit areas |
| | | with different thickness |
| Selective coating | Not supported | Accurate for any area by accurate |
| | | appliance of adhesive layer |
| Drying and | Partial and/or full drying | Partial on the fly and/or full drying |
| curing and/or | | |
| drying | | |
| Laydown | Limited to about 1 mm (defined | As much as 10-100 μm resolution |
| Accuracy | by mold), mechanical limitation | defined by drop size, DPI and inkjet |
| | | ballistics |
| Apparatus | Finite carrier and mold - pallet or | Finite pallet or loop belt with digital |
| architecture | belt | printer |
| Runs | High volume, requires specific | Any volume, one-offs, no overheads |
| | mold | per print |
| Coloration | By coating layers only; no | Built-in the process by coating layer |
| | colorization in base layer | (flocks) and/or colored ink elastomer |
| | | layers (base layer) |
| Process | Specific, single process | Combined with printer process |
| System concept | Specific | Specific or extended DTG, or R2R |
| | | textile printers |
| Process time | Long (hours), for mold | Short (minutes), for 3D print and |
| | preparation | curing and/or drying |
| Applied | Elastometer, flocks | Release layer, fixation, elastomers, |
| materials | | inks, and flocks |
| Embedded HW | NA | Supported in-line |
| Overhead | Long and expensive for preparing | None; standalone process |
| | molds | |

Embodiments of the present invention allow the following use cases in a single process on existing printers:
Creation of individual fabric pieces or continuous fabrics from consumable materials;
Any type and characteristics of fabrics can be defined per print (piece, roll) separately;
Base layer printing with specific and accurate shape and 3D attributes;
Single or double-sided flocking of printed base layer;
Creating reinforced gaps in printed base layer;
Accurate flocking control on printed or existing fabric;
Decoration of each side separately including on top of upper layer.

In some embodiments for two-sided flocked fabric, the process provided herein starts with preparing the lower flocking layer, and continues to create the base layer by digitally printing the predetermined amount and shape of the elastomeric base layer, followed by applying flocks on the top side of the fabric.

The present disclosure further includes a system (apparatus; machine; device) and a process to support the flocking steps and the digital printing; in addition, the apparatus may include two drying/curing stations: one for partial drying/curing to control and stabilize the freshly printed layers of the elastomer and the adhesive, and another one for full drying/curing of the final product providing optimal functional attributes of the elastomer/fabric.

One of the main features on the present invention is the provision of a method and an apparatus for printing a fabric having a single- or double-sided flock coating and to control its qualities by modifying the physical attributes of the materials and controlling each step of the process: flocking, printing the base layer(s) and the curing and/or drying process, all in a single digitally-controlled process. A complete process for producing a fabric can be divided into two conceptual stages: (1) creation of the base (or core) layer, and (2) coating the base layer with fibers in one or two sides. In the herein-provided process the two stages are combined to a single flow process for a single- or a double-sided flocked fabric.

### A Process

A complete process for creating a synthetic fabric, according to some embodiments of the present invention, includes the base layer and flocks coating layers (one or two sides), and affords a smooth fabric with good hand feel without using a mold or a former.
1. Set a solid support substrate in the form of a printing pallet, a conveyer belt, a plate, or the likes, to provide a platform on which the fabric will be formed, wherein the support substrate can be a sheet releasably attached to the printing pallet or the likes;
2. Apply a release layer on the support substrate, optionally in the form of a gel, which optionally be reused for more than one cycle as part of the belt or pallet;
3. Apply a first (bottom) layer of flock fibers on the release layer (by electrostatic flocking, vibration, or flocking paper) such that the release layer serves as a temporary holder for the flocks;
4. Apply (digitally print or deposit) layers of an adhesive elastomer (and/or other adhesives and/or inks) on the flock fibers held by the release layer; the elastomer creates the base layer of the fabric, glues the bottom flocks and optionally also the upper flocks in the next step. The first and last layers of elastomer can be applied in colors (e.g., CMYC) to print decorations of the backgrounds of any desired image;
5. During, or shortly after the deposition of the elastomer, perform partial drying/curing to stabilize the layers and evaporate excessive fluids. This feature of the process enable multilayer deposition including of different shapes and/or materials of the layers and/or placement of additional objects and items in-between the layers (e.g., RFID tags);
6. Optionally-apply adhesive on top of the base layer as a base for controlled flocking;
7. Optionally-place HW items (e.g., zippers, thermal glue, RFID tags, electronics circuits) in-between or above the fabric base layer;
8. Apply second (upper) layer of flock fibers by any flocking method on top of the base layer while it is wet or partially cured/dry;
9. Optionally-perform heat press if required for the flocking process (e.g., by flock sheet);
10. Optionally-print upper decoration on top of the upper flock layer;
11. Perform full curing and/or drying process;
12. Clean excessive fibers; and
13. Optionally release the fabric from the support substrate. The finished product has flock fibers on two sides of a base layer with optional decorated background on both sides.

It is noted herein that the process of forming the fabric is completed even without releasing the fabric form the support substrate, and the separation of the fabric from the support substrate is an optional step, according to some embodiments of the present invention. In such embodiments, the surface can be, for a non-limiting example, a sheet which is releasably attached to the printing machine. The releasable support substrate can be detached from the printing machine at the end of the fabric forming steps, while the fabric is still attached thereto. The finished fabric is left on the releasable support substrate, and the product, which is a fabric on the support substrate, is optionally packaged or otherwise kept until the fabric is removed from the support substrate. For example, the fabric is manufactured in one location, using a releasable substrate essentially as disclosed herein, and thereafter the support substrate and the fabric while it is still on the support substrate, are wrapped as a unified product for fabric protection reasons, and shipped to another location, where the fabric is peeled off the support substrate and used, or it is sold as is, still attached to the support substrate. Note: herein and throughout the disclosure, the term “support substrate” is used interchangeably with the term “substrate”.

Note: the accurate thickness of the base layer defines the physical attributes of the final product (stretchability, strength, breathability, etc.) and should allow the flock fibers to remain in their locations (the more adhesive, the thicker the coating). Empirically, the number of layers required to adhere the flocks is 2-4 ink layers (equivalent to 20-40 μm), and the number of layers for the base layer can be 10-100 ink layers (equivalent to 100-1000 μm).

Note: this flow describes a finite process with specific starting and ending points; however, it can be used to create continuous fabrics (e.g., creating a roll of fabric) by repeating stages 2-13 on a moving conveyer belt, one after the other simultaneously.

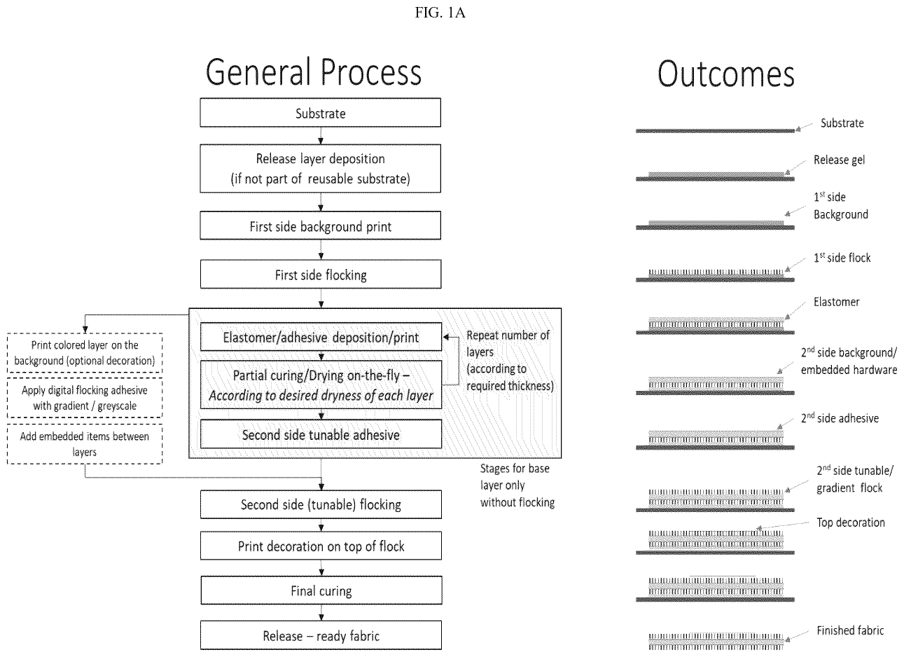

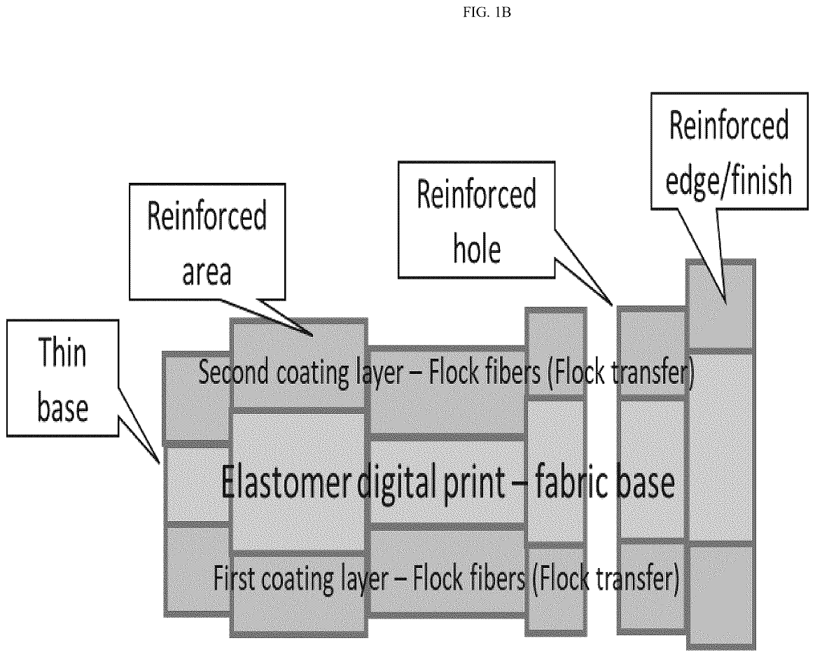

FIG. 1A presents an illustration the exemplary embodiment presented above, wherein on the left side the process is presented as a flowchart, and on the right side the outcome of each step is depicted as a side view of the emerging fabric.

The process provided herein is flexible and can be easily changed and adapted between or during the fabrication run by changing its stages and/or their order. Applying the fluids to create the different layers is effected digitally with any drop-on-demand system (inkjet printheads, jetting valves, etc.) or with hybrid system by combining the digital systems with analog systems (fixed spray, aerosol, slot die, etc.); for example, the core or base layers can be applied first with spray or jetting valves, and then can be refined by accurate printheads in specific areas, with possible real-time control over the drop size, greyscale, frequency, drop pattern and the likes.

The release layer may be reused more than one time if the bottom flocks are adequately or fully removes from it during the releasing process. In other cases, the release layer can be renewed after a one or a few cycles, and reapplied as a fresh release layer.

The process provided herein is devoid of the use of a former or a mold for any of the steps, including the step of generating the release layer (the first flocking layer, bottom flocked surface), and any of the base layer strata. In other words, the surface on which the fabric is formed, according to embodiments of the present invention, is devoid of a brim, a rim, a shoulder or any form of a raise boundary.

### Specific Use-Cases (Embodiments)

In addition to the full process embodiment of the invention, there are some use-cases embodiments for creating fabrics with specific characteristics, by different manipulations within the flow—for example:

Base layer only-without flocks or flocks on one side to achieve strong and elastic sheet, with optional decoration by digital printing over the base layer;
Cut pieces (part of garments or decorations)—by applying all the layers in specific predetermined areas (dressmaking pattern and cuts for sewing);
Reinforced portion for holes, button-loops, edges, etc.—by applying multiple layers of elastomer over these areas;
Controlled flocking—gradient, multi-color, multiple areas, etc. by applying specific densities of elastomer or adhesive before the second flocking layer or layers;
Decoration colored backgrounds on both sides—digital printing by colored elastomer layers before the final flocking;
Patterned cloth (e.g., leather-like, pique, etc.)—by controlling the elastomer layers' thickness in specific locations;
Mesh or net—by applying the layers only in the required locations;
Breathable fabric—by leaving small cavities or perforation in the layers; and
Add hardware items in-between the elastomer layers.

### Physical Attributes of the Fabric

The process provided herein allows to create a fabric of printed layers with any geometrical structure by adjusting the amount of elastomer, inks, and other materials in any location for its specific characteristics. The amount of materials in each location can be digitally set and controlled by any attribute of the digital printing process, such as ink type, number of layers, drop volume, multi-drop, gradient (greyscale), and the likes. The same can be adopted for creating mesh or net structure with holes and walls and by that controlling the complete structure and its behavior. The polymers being used, the geometry and pattern, the mesh counts, the amount of layers being applied and the amount of the crosslinkers being used in the process, can all be harnessed under a specific setup in order to create a specific fabric having desired physical features and mechanical attributes.

FIG. 1B presents a side-view illustration of a fabric created according to some embodiments of the present invention, having particular areas with specific physical attributes.

In general, when referring to the fabric using “bottom” or “top”, it is meant to refer to one of the major surfaces of the fabric in terms that correlate to the process of forming the fabric, namely the bottom layer is the first major surface of the fabric to be formed, and in the context of the fabrication machine it is the lowest and at the bottom in the stratification order, while the last layer is the highest and thus referred to as top layer.

### Apparatus

The present disclosure also provides an apparatus for effecting the presently provided process. The apparatus for continuous digital fabric creation, according to some embodiments of the present invention, is based on the process described above where all the steps are performed on the same platform, hence enable end-to-end creation of a synthetic fabric, either as a continuous roll (as in roll to roll; R2R) or as separate cut pieces, each of them with any desired shape and attributes.

The apparatus provided herein is devoid of a former or a mold, as all the steps, including the step of generating the release layer (the first flocking layer, bottom flocked surface), and any of the base layer strata, are performed on an open surface, plate or belt devoid of a brim, a rim, a shoulder or any form of a raise boundary or balustrades.

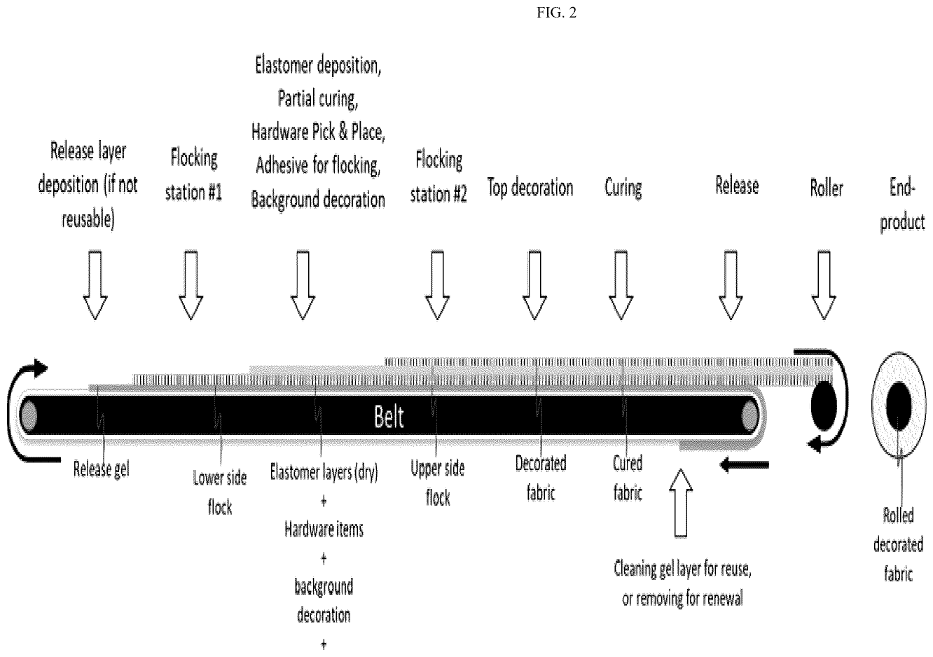

FIG. 2 is a side-view illustration of a part of an apparatus for continuous printing process of a fabric, according to embodiments of the present invention, showing that the entire process can be performed on a conveyer belt with the functional modules positioned along its path, wherein the fabric is created step by step until finally rolled as a final product.

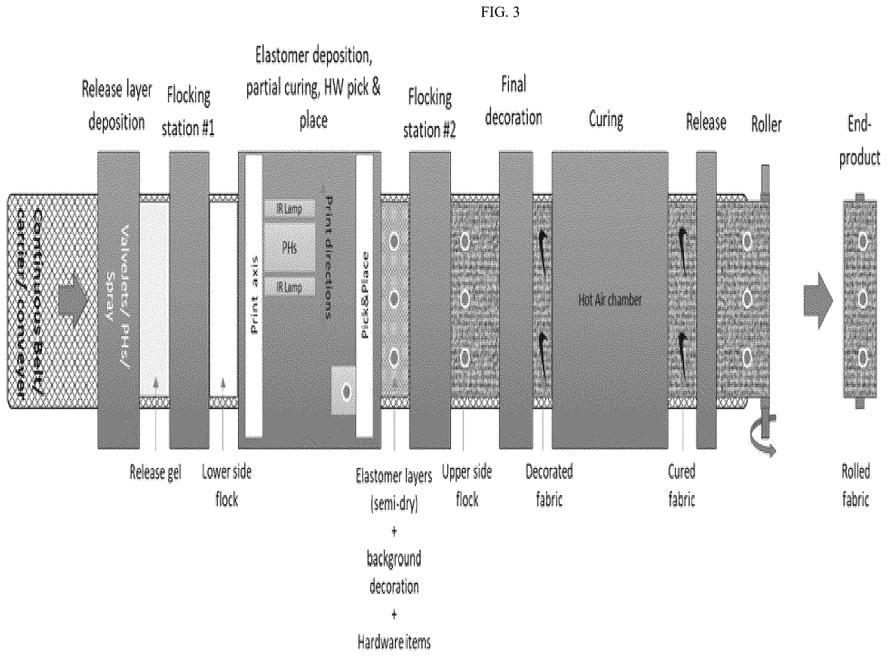

FIG. 3 is a top-view illustration of an apparatus for continuous printing process of a fabric, according to embodiments of the present invention, showing different modules, their functionality, and their optional configurations, wherein the fabric is created step by step until finally rolled as a final product.

### Conveyer Belt

A belt conveyor system is one of many types of conveyer systems that can be used in the apparatus for creating synthetic fabrics, according to embodiments of the present invention. A belt conveyer system consists of two or more pulleys (sometimes referred to as drums), with a closed loop of carrying medium—the conveyor belt—that rotates about them. One or both of the pulleys is powered, moving the belt and the created material on the belt forwards and/or backwards at predetermined speed. The belt length, width and velocity are defined in accordance with the end product attributes and the system overall throughout. For example, for a 180 cm wide fabric the belt width shall be wider; for smaller pieces the belt can be about 1 meter wide.

### Release Layer Deposition

In general, a release layer is a material that is tacky and soft and conducive to the formation of a flock layer thereon. Typically, the release layer is formed on a support surface (e.g., a part of the printing machine or a removable sheet) which can be “flocked” by any flocking method.

The material of the release layer can be integral part of the belt (as a constant or renewable coating) or deposited on the carrying belt when and where it is needed. In some embodiments of the invention disclosed herein, the belt can include a reusable release layer as an integral coating. In other embodiments, the release layer can be renewed every cycle or when the existing layer can no longer support the process.

The deposition of the release layer can be performed by spray, controlled valve jets, high volume printheads, doctor's blade, and the likes. The layer can be deposited over the entire belt or only on the areas aimed to carry the printed product, with any desired thickness, and with any accuracy that the deposition method supports.

### Lower-Flocking Station

In the context of the present disclosure, the term “flocking” refers to the active application of many small/short fibers onto an adhesive-coated surface to create a velvet-like texture.

The first flocking station applies the coating of the lower (bottom) side of the fabric. Decorative flocking is accomplished by using one of the application methods, such as electrostatic, beater bar/gravity, spraying and transfer sheets.

The electrostatic method is the most viable flocking method, especially for the printer doing more than an occasional flocking job. Flocking material can also be sprayed using an air compressor, reservoir, and spray gun similar to spraying paint. The resulting finish using this method is similar to a thin felt coating, as most of the fibers will be lying down in the adhesive. It is primarily used when large areas require flocking.

The vibration promotes the density of fibers, which is critical to good fiber coating, and causes the flocking fibers to adhere to the adhesive and pack into a layer. This process is called a beater bar or gravity flocking system and is basically a mechanical process. With this process the flocking fibers are adhered to the surface of the substrate randomly, and each fiber adheres to the adhesive at a different depth, creating an irregular flocked surface.

The common method that ensures a dense flock coverage is a combination of electrostatic flock application with the use of beater bars to help increase the density of the coating.

### Elastomer Deposition and Partial Drying/Curing

In sharp contrast to known methods of fabrication, the process and apparatus provided herein are free of the need for a mold or a former to set the shape of the base layer. The printing platform, be it a printing pallet or a belt, is used only to carry the workpiece but not to set its shape. The shape of the workpiece is set buy the printing pattern only, while the chemistry of the printing materials (immobilizing composition and the corresponding coagulating ink) and/or the partial curing/drying restrict the spreading of the inks while the emerging fabric is formed layer by later. Due to the fact that the fabric formation process of the present invention is not limited to a former or a mold to create the base layer (the main body of the fabric), it is not limited to standalone piece of fabric, and can be used to form a continuous strip of fabric that can be rolled onto a roller cylinder at the end of the process. In addition, the process provided herein can be used to form one piece of fabric at a time, but not limited to the same piece in terms of the base layer, as this can be formed according to a digital pattern that is free of a mold and can change from piece to piece without limitation (refer to as one-offs).

The deposition of the elastomer in one or more layers creates the base layer of the fabric. The first layer of the elastomer adheres to the lower flocking layer and the other layers generate the main “body” and patterns, whereas the last layer may also act as the adhesive for the second (top) flocking. The deposition can be performed using any deposition method, such as spray, controlled valve jets or printheads, depending on the desired accuracy and quality of the end product.

To enable multi-layered process with any desired thickness (e.g., 100 μm to 1 mm or more) it is required to or partially dry or cure the deposited films before printing additional layer on top of them. The partial drying or curing approach is controlled to suit the elastomer characteristics and volume, and applied during the print process to support the in-line flow of the apparatus. For example, the base layer should be almost fully dried to enable the multi-layer structure (hence the partial curing should be deeper), whereas the upper and lower layers should be tackier, or like a gel, to enable the adherence of the flocks (hence the partial curing should be weaker).

One option for the partial curing and/or drying is by moving heaters on the printheads axis that follows the jetting of the elastomer and dry the printed films instantly. The heaters can be of any drying method that reacts with the elastomer in use, such as hot air, IR emitters, UV lamps, and the likes.

For the second (upper) flock layer, an adhesive layer is printed over the films with the same elastomer or any other suitable ink. The partial curing and/or drying of this layer can be adapted to suit the required viscosity and wetness of this layer.

### Immobilization:

As discussed herein, the process is free of a mold or a former, and enjoys the benefit of applying a fixation/immobilizing composition before, during or soon after the elastomer ink is applied on the substrate, in order to limit spreading of the ink's droplets when printed directly on the support substrate or over other still wet or not fully cured layers of ink.

The concept of the fixation/immobilizing composition is presented in, for example, U.S. Pat. Nos. 9,725,848, 9,616,683, 10,472,533, 10,858,528, and 11,098,214, which are incorporated herein by reference.

Briefly, the immobilization of the ink composition, or an elastomer ink composition (can also be referred to as an adhesive composition when used to affix flocks to the base layer), is generally effected to stabilize a layer of ink at least until it is partially or fully cured. Since a layer of ink is a result of coalescence of a plurality of droplets of a highly fluid composition, such a layer can spread quickly on the surface of the substrate, particularly when attempting to form a thick base layer or add 3D features on parts of the base layer. The use of an immobilizing composition, according to some embodiments of the present invention, allows buildup of multi-layered structures by causing the liquid elastomer ink to coagulate instantly upon contacting the immobilizing composition. The instant “freezing” of the freshly printed layer prior to an optional partial curing/drying step frees the process from the limitation of a mold or a former, and allows the formation of highly delicate structural features at high spatial resolution which is unprecedented by any known fabric formation process hitherto.

Quantitatively, “immobilization” in the context of embodiment of the present invention is defined as elevating the viscosity of the adhesive/ink composition by 10-folds, 50-folds, 100-folds, 500-folds 1000-folds or 2000-folds and more. For example, when a given jetted composition is characterized by having a viscosity of 2-25 centipoises, it is defined as immobilized when its viscosity is elevated to about 2000 centipoises or higher as a result of congelation. In some embodiments, the term “immobilization” is used to refer to a sharp increase in viscosity of a liquid, such that droplets of the liquid are less prone to flowing, soaking, bleeding, spreading and/or feathering.

Hence, the chemical and/or physical change, which affects the droplets of liquid elastomer ink composition, according to some embodiments of the present invention, is generally referred to herein as “immobilization”. In the context of the chemical and mechanical change that occurs in the elastomer ink composition, according to some embodiments of the present invention, the term “immobilization”, as used herein, is interchangeable the terms “coagulation”, “congelation”, “flocculation”, “precipitation”, “thickening” or “gelation”, and vice-versa, and refer to the sharp decrease in fluidity of a formerly fluid liquid. Coagulation can be effected also by, or seen as sedimentation, precipitation, partial solidification and partial polymerization of soluble constituents in the composition. The term “sedimentation”, as used herein, refers to the destabilization of suspended colloidal or emulsified substances, such as pigment particles. The term “flocculation”, as used herein, refers to the bridging between particles by a polymer chain, causing them to form flocs or larger aggregates that might sediment or precipitate.

As presented in the patent documents listed above, while the problem of bleeding of pigment-based inks has been mitigated by using a multi-part ink system wherein a property-sensitive colored ink composition (e.g., a pH-sensitive ink composition) is immobilized as a result of a film-forming adhesion agent, a binder or a pigment dispersant in the ink coming in contact with an immobilizing composition containing an acid, this approach has not been implemented for flocking hitherto.

The coagulation of an elastomer ink composition can be afforded, according to some embodiments of the present invention, by adding to the elastomer ink composition one or more alkali-soluble property-sensitive agents (e.g., acid-sensitive or metal oxide-sensitive coagulants/agents), polypeptide-based property-sensitive agents (e.g., acid-sensitive coagulants/agents) and polysaccharide-based property-sensitive agents (e.g., divalent metal cation-sensitive coagulants/agents), or a combination thereof. According to some embodiments of the present invention, the property-sensitive agent is an alkali-soluble agent or an acid-sensitive agent.

In some embodiments, the property-sensitive agent is an alkali-soluble agent, which may be associated with dispersing or emulsifying the adhesive substance in the elastomer ink composition. The alkali-soluble agent may also not be associated with dispersing the adhesive substance, or a combination thereof. For example, a property-sensitive surfactant, dispersing agent or hydrophilic moiety can be alkali-soluble, wherein such an alkali-soluble surfactant, dispersing agent or the chemical attached hydrophilic moiety is sensitive to a decrease in pH, such as effected in the presence of an acid, whereupon contact an acid, the adhesive substance is no longer dispersed/emulsified in the carrier, causing the elastomer ink composition to coagulate (undergo sharp increase in viscosity).

In embodiments wherein the surfactant, dispersing agent or the chemical attached hydrophilic moiety are property-sensitive, they are regarded as a part of the property-sensitive agent required in the elastomer ink composition, according to embodiments of the present invention.

In the context of the present invention, a property-sensitive agent, of which the property is pH, and is sensitive to acid such that it causes coagulation of the elastomer ink composition upon contacting an acid, is also referred to as an alkali-soluble agent. According to embodiments of the present invention, alkali-soluble agents include alkali-soluble dispersants, alkali-soluble surfactants, alkali-soluble polymers, alkali-soluble coagulants and alkali-soluble gelling agents.

According to some embodiments, the alkali-soluble agent is an alkali-soluble polymer, such as, for example, an alkali-soluble acrylic polymer or alkali-soluble co-acrylic polymer such as poly(styrene/acrylic acid) polymer. It is noted herein, without being bound by any particular theory, that alkali-soluble acrylic or co-acrylic polymers are rendered soluble in alkaline conditions under-which the carboxylic groups in the polymer are charged; whereupon acidification of the aqueous medium containing the alkali-soluble polymer, the charged groups become neutral, leading to loss of solubility in aqueous media. In some embodiments, the alkali-soluble property-sensitive agent is selected from the group consisting of an emulsified polyurethane, a polyurethane polymer, a polyether polymer, a polyester polymer, a polyacrylate polymer, a polyvinyl chloride polymer, a polyvinyl acetate polymer, a polyvinyl butyral polymer, an aminosilicon polymer and any salt, co-polymer or combination thereof. Commercially available alkali-soluble polymers include Joncryl 586, Joncryl 678, Joncryl 96, Joncryl 296 and Joncryl 538.

Alkali-soluble (acid-sensitive) surfactants, suitable for use in the context of some embodiments of the present invention, include cationic surfactants. Exemplary cationic surfactant include, without limitation, commercially available surfactants such as BYK's Disperbyk® family, BYK “three-hundred” series, Air products Surfynol®&Dynol® family, BASF Plurafac® and Plurafac® family.

According to some embodiments of the present invention, the pH of the elastomer ink composition is maintained above neutral pH, namely the pH of the elastomer ink composition is higher than 7, higher than 7.5, higher than 8, higher than 8.5, higher than 9, higher than 9.5, higher than 10, higher than 10.5, or higher than 11. The pH of the elastomer ink composition can be set by the amount of all the alkali species therein, and can be further maintained at a desired level by use of an alkali pH-adjusting agent, such as a base of a buffer. Typically, the pH can be set to alkali levels by use of organic amines and/or ammonium hydroxide.

According to some embodiments of the present invention, the immobilizing composition is formulated to carry and deliver a property-adjusting agent to the substrate, and does not contain an adhesive substance, a colorant, or flock, and is thus substantially transparent and colorless, and intended not to leave a distinguishable mark on the substrate. Thus, according to some embodiments of the present invention, the immobilizing composition is essentially devoid of an adhesive, a colorant, pigment and/or dye.

The mechanical properties of the immobilizing composition presented herein are correlated, at least to some extent, to the properties of the liquid applicator used to apply the composition on the substrate. Suitable applicators include high-output capacity spray nozzles that are typically used to cover relatively large area of the substrate at relatively low resolution, and inkjet printheads, the latter being more delicate and complex and used for accurate drop placement (high resolution) at relatively low-output capacity. For simplicity, the term “nozzle” is used herein to refer to the high-output low resolution liquid applicator, and the term “printhead” is used to refer to the low-output high resolution liquid applicator. Output capacity may also be affected by the relative speed by which the applicator moves over the substrate (or the substrate moves under the applicator) during the printing process, however the output capacity is determined while taking that relative motion into account by reporting the total amount of liquid that is being delivered to a unit area at a unit time. A typical printhead delivers ink according to the varied digitized color requirements at any given image segment (“pixel”), pallet motion and printhead frequency, while a typical spray nozzle delivers constant amount under constant pressure of liquid over time, varied by pallet motion. For an exemplary comparison, a spray output capacity of a nozzle ranges about 4-5 grams per square inch at a pressure of about 1.5 bar, while the jetting output capacity of a printhead ranges about 0.002-0.05 grams per square inch. For example, for 600 DPI prints (360,000 pixels in square inch), using 4 μl drop for one pixel, the spray output capacity translate to about 1.44* μl per square inch or about 1.44 mg per square inch, and for using 80 μl drops, about 0.03 grams per square inch.

The immobilizing composition presented herein is formulated so as to be suitable for application thereof in-line of an inkjet printing process. In other words, the immobilizing composition is designed to be applied directly on the substrate as part of the printing process rather than a pretreatment step before the printing process, which can take place off-line of the inkjet printing process. Such formulation incurs some limitations of the immobilizing composition, particularly in the sense that the composition is required to be suitable for inkjet applicators that form a part of the inkjet machinery, and particularly the parts that involve direct inkjet printing.

According to some embodiments, when the immobilizing composition is designed to be applied (sprayed) by a nozzle, its ingredients are selected and/or treated such that the composition exhibits or characterized by attributes suitable for the means of printing/spraying.

An exemplary property is a pH-dependent dispensability and ionic-strength-dependent dispensability, also referred to herein as “alkaline dispensability”, wherein the change in pH (the aforementioned acidity or alkalinity property) or the ionic-strength of a solution changes the dispensability of one or more of its dispersed species. Similarly, there exist inter-dependency between metal ion complexation combined with pH, and the capacity to stay dispersed/emulsified, and such interdependency is discussed in detailed hereinbelow. A property-adjusting agent that acts by adjusting the pH of the environment of a pH-sensitive agent, is therefore a pH-adjusting agent.

According to some embodiments of the present invention, the pH of the immobilizing composition is acidic due to the nature of the property-adjusting agent, being an acid. In such embodiments, the pH of the immobilizing composition is lower than 6.5, or ranges about 2-6, or about 2-5, or about 2-4. Optionally, the pH of the immobilizing composition ranges about 3-6, 4-6 or 5-6. The immobilizing composition may or may not contain a buffering agent. According to some embodiments, an immobilizing composition may be buffered by a suitable salt or weak base, such as ammonia/ammonium base or another volatile amine, to ensure the desired pH range while not leaving undesired traces on the substrate. Buffering may be accomplished by a buffering agent, such as, but not limited to a weak amine such as tris(hydroxymethyl aminomethane), also referred to as Tris or THAM.

Almost any small molecule acid, organic acid or polymeric acid will cause an ink composition containing a pH-sensitive agent to coagulate/congeal, and some acids might be more preferable for use in some embodiments and printing conditions and tasks. Less favorable acids include acids that impart a noticeable odor, or may burn-out the substrate, or leave a stain in the substrate, or cause a dye in the ink composition or the substrate to migrate or otherwise be diminished. According to embodiments of the present invention, pH-adjusting agents include glycolic acid (volatile), acetic acid (volatile with some vinegar odor), lactic acid (dimerized at elevated temperatures), malic acid, ascorbic acid, maleic acid, benzoic acid and several polymeric acids (acidic polymers).

Exemplary acidic polymers, which can be used beneficially as polymeric property-adjusting agent in the context of embodiments of the present invention, include, without limitation, polyacrylic acid, acidic alkoxylated polymer, poly(2-acrylamido-2-methylpropanesulphonic acid), poly(acrylic acid-co-maleic acid), poly(butadiene-co-maleic acid), poly(ethylene-co-acrylic acid), polymaleic acid, poly(methacrylic acid), poly(4-styrenesulfonic acid-co-maleic acid), and any mixture thereof.

### Optional Printing Features

Create 3D patterns on of the base layer;

Add digital printing of background on top of the base layers as a decoration of the upper side of the product;

Add controlled flocking (multi-color, gradient, greyscale, etc.); and

Use colored elastomer with multiple printheads (e.g., CMYK) to print any image on the bottom and the top of the fabrics.

### Optional Accessories

Place prefabricated hardware items before, during, or after printing the elastomer layers by a pick-and-place mechanism; items may include any garment accessory and/or decorative element, such as zippers, buttons, glue strips, electronics devices, tags, threads, interlining, labels, motif (leather, plastic, batch metal), pocketing fabric, lining, interlocking nylon strips, elastic, cord, ribbon, toggles, rivets and collar bones. Finishing accessories can also be incorporated into the fabric formed according to embodiments of the present invention, and include, without limitation, hang tags, price tags, plastic/poly bags, tissue paper, carton, scotch tape, belt, tag pins, plastic clips, stickers, butterflies, collar inserts, back boards, necks insert, and the likes.

### Upper-Flocking Station

The apparatus station for the upper flocking for the upper side of the fabric can be similar to the first flocking station, or different. The upper flock layer can be formed with a different flocking method and different flock fibers in accordance with the desired hand-feel and pattern of the product.

### Final Decoration Printer

Any digital inkjet printer can be used to apply any image on top of the upper flock layer.

### Wet-on-Wet Stabilization

The use of an immobilizing composition during the printing process prevents premature spreading of the fluid ink on the substrate or the previously applied layer, and therefore allows the stratification of wet layers one on top on the other even before partial or final curing/drying.

Curing and/or Drying

In the context of the present disclosure, the term “cure/dry” is equivalent to the phrase “cure and/or dry”. Partial curing/drying during the process allows the creation of a thicker fabric, the addition of relatively “tall” 3D features (embossed/relief features), fortification of structural elements in the fabric, multicolor elements, and many other mechanical and structural features that are made possible due to the stabilization of the freshly applied layers on ink. Final curing and/or drying of the product for complete drying and stability can be carried out by any curing/drying device known in the art. For example, hot air at 110 °C for 2-4 minutes, whereas temperature and duration depend on the ink and the amount thereof).

### Release Mechanism

The final extraction the fabric from the release layer (e.g., a gel) can be effected by mechanical separation and/or heating the surface. This step can also remove excessive flock fibers and other debris.

### Roller or Plate

While the process and apparatus for creating a synthetic fabric provided herein are free of a former or a mold, the fabric creation takes place on any flat, borderless surface, which has to be sufficiently large to support the entire workpiece. A typical stationary or moving printing pallet (substrate plate) can be used to create a standalone piece of fabric, while a moving belt can be used to form a continuous strip of fabric that can be rolled on a roller at the end station of the printing machine. Hence, a roller can be used to collects the final product in the production of a continuous fabric, according to some embodiments of the present invention.

### Gel Cleaner or Remover

In some embodiments, the release layer is configured for a single usage, in which case the device of the apparatus for treating the release layer removes the layer and cleans the substrate, preparing it for a fresh release layer deposition. For multi usage of the release gel, the device of the apparatus for treating the release layer is configured to clean and renew the gel every predefined number of cycles.

### Elastomer Layer

The physico-chemical properties of the elastomer is formulated for applying by inkjet printheads. In some embodiments thereof, the present invention encompasses chemically cross-linkable binder compositions suitable for inkjet printing that may include one or more water soluble/dispersible polymers bearing certain mechanical and fixation properties. The compositions may further include a blocked polymerization crosslinker which undergoes activation under thermal conditions. The compositions may further include additional substances such as solvent, humectant, pH modifier, surfactant and the likes.

The compositions may exhibit the following characteristics to operate satisfactory within an inkjet printing system: low viscosity values of below 30 centipoises at a temperature of 25-35 °C to allow jetting through inkjet nozzles, appropriate surface tension of about 26 to 38 Dyn/cm to allow continuous jetting of the liquid compositions, Newtonian liquid behavior and inert to external shear thinning such as circulation in order to avoid any gelation or precipitation of dispersed binder.

For 3D fabric printing, a cured elastomeric composition may exhibit a tensile strength of above 10-80 MPa, elongation of 50-300%, and more preferable tensile strength of 15-35 MPa with elongation of 100-150%, low shrinkage and low curling following drying procedure. Of note, tensile strength of polyester and cotton-based fabrics vary between 10-25 MPa, respectively, while elongation at break is ranging between 400% and 100%, respectively.

Finding a single jetable binder that exhibits high tensile strength (>25 MPa) and relatively high elongation at break (>200%) is almost impossible, hence a mixture of at least two types of binders is required to meet the required mechanical properties of the final product. At least one of the binders is selected for endowing the composition with tensile strength and other substances are selected for the elongation property. A synergic effect of the mixture can improve the mechanical properties of the final product.

Following above, preferable binder mixtures are as follows:
1. Binders with very high tensile strength (above 25 MPa), but relatively fragile. For example, a water-based polyurethane-carbonate copolymer resins with self-cross-linking property by the evaporation of water makes it a relatively hard film with hydrolysis-resistance, stain and water resistance properties. On the other hand, it is very tough and fragile. Its concentration may range 30-70%.
2. Binders with higher elongation at break than the 1st binder (above 400%), but less strength. For example, a nonionic modified polyurethane based finishing and softening agent. These substances bestow an elastic and gummy touch. The tensile strength is low (<4 MPa). Its concentration may range 5-60%.

A hybrid combination of above binders which exhibit both moderate tensile strength (above 20 MPa) and elongation (above 400%) at break are preferable than each binder as a single binder.

In general, any jetable binder may be of use in the context of the present invention, as long as it is adapted to the printing machine parameters, and these include silicon-based binders, polyurethane-based binders, acrylic-based binders and mixtures thereof.

Tables 2 and 3 present various binders and additives for the elastomer ink composition, respectively.

TABLE 2

| | | | tensile | elongation |
|---|---|---|---|---|
| | | | strength | at break |
| Trade Name | Chemical Type | Supplier | [MPa] | [%] |
| Joncryl 3772 | Polyacrylate binder | BASF | 26 | 472 |
| Joncryl 3791 | Aliphatic polyurethane | BASF | 4.2 | 426 |
| | dispersion | | | |
| Lubrijet T805 | polyurethane dispersion | Lubrisol | 20.5 | 231 |
| Lubrijet T800 | Aliphatic polyurethane | Lubrisol | 5.6 | 390 |
| | dispersion | | | |
| Lubrijet T340 | Acrylic dispersion | Lubrisol | 1.4 | 399 |
| Rolflex DV5 | Aliphatic polyurethane | Lamberti | 21.1 | 845.8 |
| | dispersion | | | |
| Purlastic RT soft | Anionic polyurethane | Polysistec | 2.9 | 810 |
| | dispersion | | | |
| Alberdingk ® U | Aliphatic polyurethane | Alberdingk | 25.6 | 521 |
| 4000 | dispersion | Boley | | |
| CROMELASTIC | Anionic polycarbonate- | Cromagenia | 17 | 350 |
| PC 250 PRG | based aliphatic | | | |
| | polyurethane dispersion | | | |
| DAOTAN TW | aqueous aliphatic | Daotan | 9.7 | 447 |
| 6431/45WA | poly(urethane-urea)- | | | |
| | dispersion | | | |
| PERICOAT PU | anionic polyurethane | Dr Petry | 16.2 | 813 |
| 326 | dispersion | | | |
| PERICOAT PU | anionic polyurethane | Dr Petry | 5.6 | 718 |
| 325 | dispersion | | | |
| Taklac WS-6110 | polyether-based | Mitsui | 6.9 | 405 |
| | polyurethane dispersion | | | |
| Taklac WS-6021 | polyether-based | Mitsui | 16 | 710 |
| | polyurethane dispersion | | | |

TABLE 3

| | Function in the |
|---|---|
| Chemical Type | formulation |
| 1,3 propylene glycol | Humectant |
| Triethylene glycol | Humectant |
| Glycerol | Humectant |
| Deionized water | Carrier/solvent |
| Polyether-modified | surfactant |
| siloxane (e.g., BYK-349) | |
| Triethanolamine 85% | pH modifier |

Table 4 presents three exemplary elastomer ink compositions, useful in the context of embodiments of the present invention. The mechanical properties of the exemplary compositions are: tensile strength above 20 MPa and elongation above 150%.

TABLE 4

| | Example | | Example |
|---|---|---|---|
| | 1 | Example | 3 |
| Chemical name (Trade name) | (w/w %) | (w/w %) | (w/w %) |
| 1,3 Propylene glycol | 13 | 2 | 12 |
| Triethylene glycol | 0 | 14.6 | 0 |
| Glycerol | 5 | 5 | 4 |
| Aliphatic PUD (Rolflex DV5) | 10.6 | 0 | 0 |
| PUD emulsion (Lubrijet T805) | 0 | 35 | 0 |
| Aliphatic polyurethane | 55 | 22 | 43.6 |
| dispersion | | | |
| (Alberdingk ® U 4000) | | | |
| Polycarbonate based | 5 | 15 | 28 |
| PUD (Taklac WS4000) | | | |
| Triethanolamine 85% | 0.4 | 0.4 | 0.4 |
| Deionized water | 11 | 6 | 12 |

### Release Layer Composition

The release layer is preferably selected from a material that can hold flock fibers temporarily during the pretreatment (fixation spray/inkjet) and the print process, until the upper layers of the product are printed, and then allow a clean and easy release of the flocks of the bottom layer from the support substrate. It can therefore be said that the release layer is releasably attached to the fabric, whereas releasing involved peeling off and possibly washing the bottom flock layer from residues of the material comprised in the release layer.

In some embodiments, the material of the release layer is required to be washable, or otherwise be selected such that it can be removed at least from the fabric, and optionally also from the substrate. The release layer is therefrom a transient, washable layer of a tacky soft material, which is mechanically and chemically suitable for flocking. The release layer is optionally detached from the fabric at the end of the process, essentially by peeling the fabric off the substrate, leaving the release layer on the substrate, and/or by washing or otherwise cleaning the fabric from residues of the material of the release layer.

In the context of the release layer, the term “transient” refers to a property of the release layer. By referring to the release layer as “transient”, it is mean that although the release layer is an integral part of the process of forming the fabric provided herein, it is not necessarily a part of the finished fabric, and its transientness involves peeling-off the fabric from the release layer, and/or washing the release layer off from the fabric after separating the fabric from the release layer.

The release layer is preferably a liquid or at least fluid (viscosity of 100-100,000 cPs at 25 °C) to be spread as a unified layer and to enable the flock to penetrate through, but thick enough (20 micron and higher) and sticky enough to maintain itself and attach the flock fibers throughout the process. Moreover, the coating layer should exhibit weaker adhesion than the elastomer to the flock and this is in order to be released after the print and cross-linkage stage. In other words, the affinity to the blanket/belt, i.e., coating layer+carrier, should be lower than the affinity to the flock+ink in order to allow it to be released in a later stage.

The purpose of the release layer is to allow initial adhesion of the flock fibers to the carrier pallet or belt (that might be PET, PP film, PU belt, aluminum plate, etc.) following flock deposition and inkjet deposition of the elastomer layer and finally additional flock deposition. Obtained structure is exposed to drying/curing and/or drying conditions (radiation, hot air at 100-160 °C) in order to evaporate solvents and cure the elastomer layers. Finally, the release layer should be removable by simple peel off or other chemical or physical means for removal and cleaning.

In general, the release layer composition can be a natural or synthetic hydrogels or a hydrocolloid, including, but not limited to pectin, alginate, gelatin, METHOCEL™ (a brand of cellulose ethers produced by DuPont), CELLOSIZE™ (a brand of hydroxyethyl cellulose products produced by Dow Chemicals) and the likes, or a silicone-based substance, and any combination thereof.

In some embodiments the release layer composition is configured to meet certain requirements in accordance with the following:

For fiber and elastomer deposition, softness should allow penetration of 40 mm/10 and higher for gels, and Shor A of 50 and lower for rubber; peel force, which defines tackiness properties should be about 1 N/25 mm and higher in order to reach initial adhesion of fibers to the layer. For release characteristics, the surface tension should be up to 40 mN/m, and the peel force about 3 N/25 mm. Penetration measurement is performed using DIN ISO 2137, and peel force measurement is defined using 1800 peel off test.

Silicon-based release layer compositions (polyorganosiloxanes) suitable for draw down/slot die or valve jet that may include one or more solventless silicon A/B mixtures bearing certain mechanical and curing and/or drying properties using addition polymerization mechanism. Polyorganosiloxanes include variety of silicon products like RTV-2 (room temperature vulcatization) and LSR (liquid silicon rubber) which are known as two component materials, and RTV-1 which is known as one component silicon.

Compared to other materials, silicones exhibit many properties that might be beneficial in context of a release layer, according to embodiments of the present invention, i.e., water-repellence, also known as hydrophobicity, low surface tension, thermal and dimension stability, and elasticity. Silicone-based compositions may exhibit the following characteristics to operate satisfactory: viscosity values of about 100-100,000 centipoises at a temperature of 25 °C to allow draw down/slot die, or valve jet. Suitable silicones include, for example, Silopren LSR 2530 A/B (Momentive), Elastosil LR 3003/40 A/B (Wacker), SILOPREN GEL 4950 A/B (Momentive), SilGel 612 A/B (Wacker), SilGel 613 (Wacker) and TSE 3062 A/B (Momentive).

Water-based release later substances are also contemplated. The present invention is also directed to inert aqueous synthetic and non-synthetic polymer solutions suitable for draw down/slot die or valve/ink jet that may include one or more copolymer mixtures bearing certain chemical, mechanical and gel forming properties upon exposure to water, but not necessarily (i.e., like PEG which does not form gel in water). Proper release of the 3D printed fabric from support layer is defined by weak adhesion of the support to the flock fibers following drying/curing and/or drying process. In addition, but not necessary is efficient drying of the polymer solution/gel coating to remove water under certain thermal conditions in order to make gel become solid coating prior printing process.

The release layer composition can be applied by analogue equipment (spray, nozzles, slot die) and/or by digital equipment (valve jet, inkjet printheads). Support substrate preparation, i.e., PET/PP film, PU belt, Al plate coated with a release layer composition can be conducted prior and also as inline printing process of the fabrics, according to some embodiments of the present invention. In both cases, it should be dried (i.e., temperature can vary from 80 to 160 °C depended on the applied layer thickness) prior digital activation process with jetted immobilizing composition (FoF; also known commercially as “Q.Fix” by Kornit) on the fly, which converts dried polymer coating to a kind of “hydrogel” due to its high absorption properties in the areas exposed to the immobilizing composition. Once activated area of the release layer is exposed to flock deposition, the flock should penetrate easily inside the release layer. Once the release layer coating is ready, printing process is conducted as follows: flocking step, elastomer deposition step (possibly with simultaneous curing and/or drying), flocking step, drying/curing and releasing.

Various polymer-based compositions can be used for the purpose of the release layer. The coating procedure is conducted using aqueous solution of mentioned above and drying prior usage. The activation is applied using an immobilizing composition (commercially known as “Q.FIX” by Kornit) digitally following by printing process of the 3D fabrics as described previously.

In order to achieve good release, it is preferable, but not must, to apply polymers that tend to be liquid following drying & curing and/or drying test in thin layers. For example, PEG does not fully re-crystalize following 160 °C in thin layers and thus allows clear release of the flock from support. Similar behavior was found with Rheovis 1330 (BASF) polyether structure.

Table 5 presents three exemplary release layer compositions, according to some embodiments of the present invention.

TABLE 5

| | Example | Example | Example |
|---|---|---|---|
| | 1 | 2 | 3 |
| Chemical name (Trade name) | (w/w %) | (w/w %) | (w/w %) |
| Polyethylene glycol (PEG 4000) | 49.9 | | |
| Sulfosuccinate (Byk 348) | 0.2 | | |
| Polyvinyl alcohol | | 20 | |
| (KURARAY POVAL 26-88) | | | |
| Alginate | | | 10 |
| (Kimica Algin ULV-5) | | | |
| Water | 49.9 | 80 | 90 |

### Sustainability and Green Aspects

The process provided herein in sustainable mainly since it allows to print on demand, only what is needed, in one location, and therefore with minimal waste and energy, as well as of logistics, shipping and delivery phases. Flocks can be obtained from recycled fibers. By developing the optimal elastomer for fabric creation, one can reduce the use of volatile organic compounds, reduce electrical power usage, and reduce emittance level.

### The Fabric

According to some embodiments of the invention provided in the present disclosure, the fabric resulting from the process described herein is formed by, inter alia, applying a release layer on a surface, flocking the release layer with a first flock material to create a bottom flock layer, and then printing a first elastomer ink composition on the bottom flock layer to create a first elastomer layer. This first elastomer layer is then partially cured and/or dried to create a partially cured/dried elastomer layer. A second elastomer ink composition is then printed on the partially cured/dried elastomer layer to create a second elastomer layer, which is then flocked using either the first or a second flock material to create a top flock layer. The fabric is then cured or dried and optionally released from the surface. The process can be repeated multiple times to create additional elastomer layers, and each elastomer ink composition can be individually colored and printed on the same or different areas. The printing can also be done with an immobilizing composition. The surface can be a moving or stationary printing pallet, conveyor belt, or plate, or a sheet that can be detached from the printing machine while the fabric is still attached thereto. The release layer can be in the form of a gel and used for single or multiple uses.

Preformed objects such as zippers, buttons, RFID tags, etc. can also be placed on or in the elastomer layer. The top flock layer can also be heat pressed and/or have a colored ink composition printed on it before curing/drying.

In some embodiments, the elastomer layer is devoid of a preformed object, and particularly devoid of a preformed mesh.

Overall, this process results in a fabric with multiple layers of elastomer and flock material, which can have various colors and preformed objects incorporated into it. The fabric can be described as a multi-layered fabric composed of elastomer and flock material. The fabric has a bottom flock layer, one or more elastomer layers, and a top flock layer. The elastomer layers can be of different colors and can have pre-formed objects such as zippers, buttons, RFID tags, etc. incorporated into them. The top flock layer can also have a colored ink composition printed on it. The fabric is formed on a release layer, which can be in the form of a gel and used for single or multiple uses.

Since absolute cleaning off of all traces of residues of the material that is used for the release layer may be impractical, considering the delicacy of the flocked surface, it can be said that the fabric provided herein is characterized by comprising at least some traces of the release layer at least in the bottom flocked layer, which can be detected using standard chemical analysis methodologies known to any skilled artisan of the relevant field.

In the context of some embodiments of the present invention, a finished fabric, namely a fabric that has been released from the support substrate, is likely to retain some of the release layer composition, which may or may not be washed, and may or may not leave some residue of the release layer composition, or at least traces of at least one of the ingredients of the release layer composition. Hence, in some embodiments, the fabric is characterized by trace residue of at least one ingredient of the release layer composition.

In the context of such embodiments of the present invention, the term “trace” refers to a small but detectable amount of a substance, which can be estimated to be less than about 1% of the total mass of the fabric after it had been release from the support substrate. Alternatively, a trace amount of at least one ingredient of the release layer composition in the fabric is less than 0.1% or less than 0.01% by weight of the total weight of the released fabric. For example, a trace amount of at least one ingredient of the release layer composition left in or on the released (finished) fabric is typically less than about 1 gram, less than about 0.1 gram or less than about 0.01 gram per 100 grams of a fabric as presently disclosed.

Traces of the at least one of the ingredients of the release layer composition can be detected using analytical methods like FTIR, NMR, LC-MS; preferably FTIR.

In some embodiments, the fabric can be left on the support substrate, and optionally be peeled-off the support substrate.

It is expected that during the life of a patent maturing from this application many relevant processes for inkjet printing of 3D objects will be developed and the scope thereof is intended to include all such new technologies a priori.

As used herein the term “about” refers to +10%.

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the phrases “substantially devoid of” and/or “essentially devoid of” in the context of a certain substance or a composition, refer to a composition that is totally devoid of this substance or includes less than about 5, 1, 0.5 or 0.1 percent of the substance by total weight or volume of the composition. Alternatively, the phrases “substantially devoid of” and/or “essentially devoid of” in the context of a process, a method, a property or a characteristic, refer to a process, a composition, a structure or an article that is devoid of a certain process/method step, or a certain property or a certain characteristic, or a process/method wherein the certain process/method step is effected at less than about 5, 1, 0.5 or 0.1 percent compared to a given standard process/method, or property or a characteristic characterized by less than about 5, 1, 0.5 or 0.1 percent of the property or characteristic, compared to a given standard.

When applied to an original property, or a desired property, or an afforded property of an object or a composition, the term “substantially maintaining”, as used herein, means that the property has not change by more than 20%, 10% or more than 5% in the processed object or composition.

The term “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The words “optionally” or “alternatively” are used herein to mean “is provided in some embodiments and not provided in other embodiments”. Any particular embodiment of the invention may include a plurality of “optional” features unless such features conflict.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

As used herein the terms “process” and “method” refer to manners, means, techniques and procedures for accomplishing a given task including, but not limited to, those manners, means, techniques and procedures either known to, or readily developed from known manners, means, techniques and procedures by practitioners of the chemical, material, mechanical, computational and digital arts.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Various embodiments and aspects of the present invention as delineated hereinabove and as claimed in the claims section below find experimental and/or calculated support in the following examples.

### EXAMPLES

Reference is now made to the following examples, which together with the above descriptions illustrate some embodiments of the invention in a non-limiting fashion.

### Example 1

a Piece of Fabric with Double-Sided Flocking

For proof of concept of some aspects of the present disclosure was carried out as described below. Specifically, a two-sided flock-coated elastic fabric piece, formed from scratch on a digital printer.

### Materials and Machinery:

A transparent film for use as support layer (can be replaced by a continuous print platform belt);
A silicone gel (SilGel® 612 A/B by WACKER; when fully cured forms a tacky gel);
Flock fibers: 0.5 mm length, 1.7 dtex, viscose/polyamide;
Wet-on-wet coagulation (immobilizing) composition (Kornit's “FoF”; “Q.Fix”); Elastomer ink-Kornit NeoPigment™ Olympia ink
Doctor blade applicator (automatic film applicator by BYK Gardner USA);
Kornit Atlas Max Direct to Garment (DTG) Drop On Demand (DoD) printer, equipped with elastomer ink and immobilizing composition channels (designated printheads);
Electrostatic coater, DCA Fabricoat Series 100/200 used at about 30 KV;
Belt dryer;
Oven; and
Air gun.

### Process/Method Steps:

1. Coat the transparent film with 100 μm of the silicone gel using the doctor blade applicator;
2. Cure the silicone coating in an oven for 10 minutes in 110 °C;
3. Apply flock to the silicone film with the flock fibers using the electrostatic coater;
4. Gently shake off excess flock from the film;
5. Print immobilizing composition alone on a 15×15 cm square area, 6 layers=600% coverage for support of the elastomer layer that follows on top;
6. Print a 15×15 cm square using:
   Kornit Atlas Max
   elastomer ink with 800×800 DPI
   4 channels for elastomer in
   1 channel of immobilizing composition (using 100% while printing)
   5 layers (500% coverage)·
   30 pL drop volume;
7. Apply flock to the printed square (same method as in step 3);
8. Dry for 10 minutes at 110 °C;
9. Wait to cool and gently peel the workpiece from the support layer;
10. Dry for 20 minutes at 160 °C to full cure; and
11. Wait to cool and clean with an air gun the excess flock.

For this proof of concept, the drying unit was not attached to the printing machine, so on Step 9 the workpiece is manually transferred to the drying belt in the oven. At this stage the flock fibers are released from the silicone layer and stay attached to the elastomer's bottom side, and the elastomer is not fully cured.

The resulting double-sided flocked elastomeric sheet is a strong yet elastic fabric, characteristics of which are presented in Table 6 below.

TABLE 6

| | Testing | | | Acceptable fabric | | |
|---|---|---|---|---|---|---|
| Parameter | equipment | Result | | values (standard) | | comments |
| Hand Feel | Tissue Softness | 32.9 | | 1-40 | | Algorithm |
| | Analyzer | | | | | QA 1 |
| | (TSA) | | | | | |
| Stress at | Lloyd LS1 | 4.2 | Mpa | 3-25 | MPa | |
| break | | | | | | |
| Elongation | Lloyd LS1 | 410% | | 20-350% | | |
| at break | | | | | | |
| Thickness | Analog | 700 | μm | 500-1500 | μm | |

thickness
gauge

As can be seen in Table 6, the resulting fabric falls within or better than the industry's acceptable standards for fabrics.

### Example 2

Decorative Lace with Reinforced Edges

For proof of concept of another aspects of the present disclosure was carried out as described below. Specifically, a two-sided flock-coated elastic fabric piece, having holes, relief and embossed structural elements, formed from scratch on a digital printer.

Materials and machinery are as described in Example 1 hereinabove.

### Process/Method Steps:

1. Coat a transparent film with 100 μm of silicone gel (a silicone that when fully cured is a tacky gel like form) using the film applicator;
2. Cure the silicone coating in the oven for 10 minutes at 110 °C;
3. Apply flock to the coated film using the electrostatic coater at ~30 KV, and the flock fibers;
4. Gently shake off excess flock from the film;
5. Print a square of immobilizing composition in 6 layers on an area that encompasses the entire lace print;
6. Print the lace pattern of hexagonal mesh using:
   Kornit Atlas Max;
   8 layers of elastomer ink at 800×800 DPI by 4 channels;
   30 pL drop volume; and
   immobilizing composition in one channel (using 100% while printing);
7. Print the second pattern over the first mesh pattern to add a stitch effect along the edges, using the same parameters as in step 6;
8. Apply flock to the printed workpiece (same method as step 3)
9. Dry for 10 minutes at 110 °C;
10. Wait to cool and peel the elastomer from the support layer;
11. Dry for 20 minutes at 160 °C to full cure; and
12. Wait to cool and clean with an air gun the excess flock.

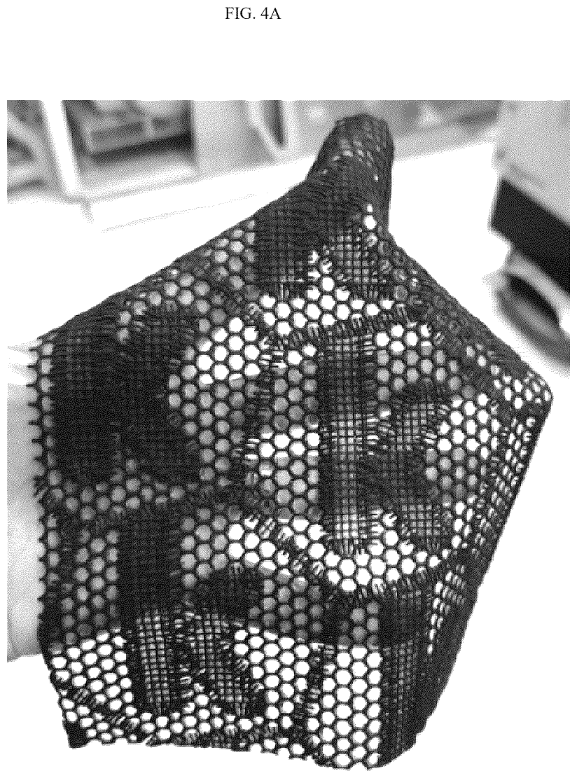

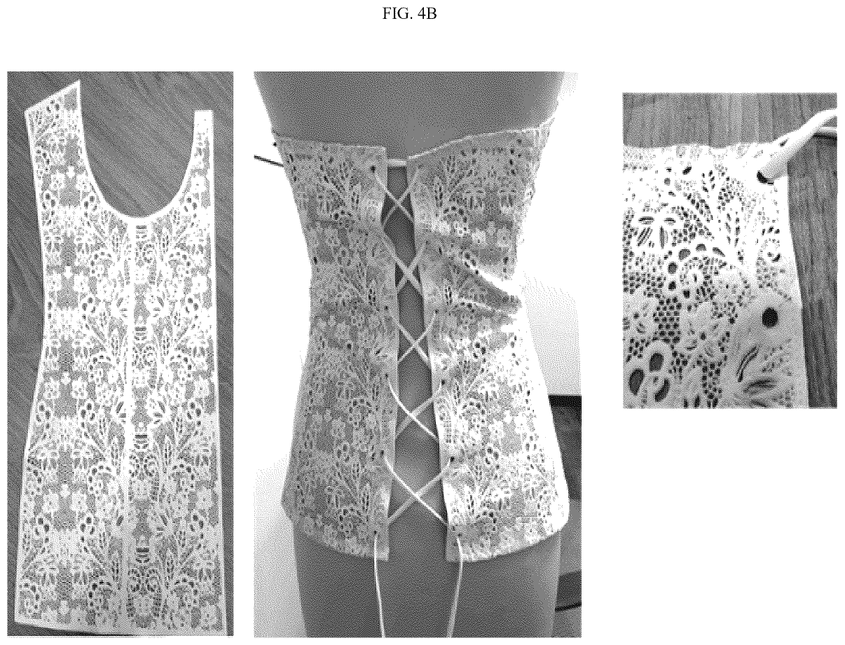

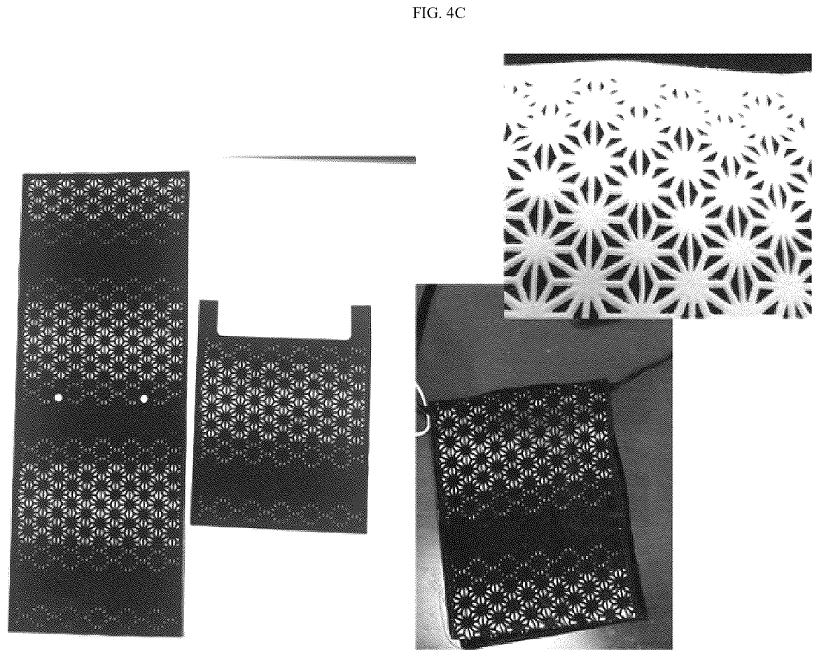

FIGS. 4A-C present black and white photographs of lace-like fabrics produced according to some embodiments of the present invention, showing lace with stitch effect (A), lace garment with reinforced edges around holes (B), and lace pieces with variable coating thereon (C).

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting.

In addition, any priority document(s) of this application is/are hereby incorporated herein by reference in its/their entirety.

1. A process of forming a fabric, comprising:
i. applying a release layer composition on a surface;
ii. flocking said release layer using a first flock material to afford a bottom flock layer;
iii. printing a first elastomer ink composition on said bottom flock layer to afford a first elastomer layer;
iv. partially curing and/or drying said first elastomer layer to afford a partially cured/dried elastomer layer;
v. printing said first elastomer ink composition or a second elastomer ink composition on said partially cured/dried elastomer layer to afford a second elastomer layer;
vi. flocking said second elastomer layer using said first flock material or a second flock material to afford a top flock layer;
vii. curing and/or drying the fabric; and
viii. optionally releasing the fabric from said surface,
thereby affording the fabric,
wherein said surface is devoid of a raise boundary.

2. The process of claim 1, further comprising, repeating steps iii-v n times to afford an n^{th} elastomer layer, wherein:
n is an integer; and
each repetition uses an n^{th} elastomer ink composition; and
each of said n^{th} elastomer ink composition can be the same or different from said first elastomer ink composition, said second elastomer ink composition, or any other previously used elastomer ink composition.

3. The process of claim 2, wherein each of said first elastomer ink composition, said second elastomer ink composition and/or said n^{th} elastomer ink composition is individually colored.

4. The process of claim 2, wherein each of said first elastomer ink composition, said second elastomer ink composition and/or said n^{th} elastomer ink composition is individually printed on the same or difference area.

5. The process of claim 1, wherein at least one of said printing is effected with an immobilizing composition.

6. (canceled)

7. The process of claim 1, wherein said release layer is in a form of a gel.

8. (canceled)

9. The process of claim 1, further comprising, placing at least one preformed object on or in said elastomer layer.

10. (canceled)

11. The process of claim 1, further comprising, subsequent to step vi, heat pressing said top flock layer.

12-15. (canceled)

16. An apparatus for forming a fabric, comprising:
a surface in the form of a moving or a stationary printing pallet, a conveyer belt, or a plate, having a release layer applied thereon;
a first flocking station;
a digital printing station; and
a curing/drying device,
wherein said surface is devoid of a brim, rim; shoulder.

17. The apparatus of claim 16, further comprising, a second flocking station downstream of said digital printing station.

18. The apparatus of claim 17, further comprising, a heat-press station downstream of said second flocking station.

19. The apparatus of claim 16, further comprising a release layer applicator for applying said release layer on said surface.

20-23. (canceled)

24. The apparatus of claim 16, further comprises means for adding hardware items to the fabric.

25. The apparatus of claim 16, further comprises means for partial curing/drying before, after, or during printing.

26. A fabric, manufactured by the process of claim 1.

27. A fabric, manufactured by the apparatus of claim 16.

28. A multi-layered fabric comprising:
a bottom flock layer,
at least one elastomer layer, and
a top flock layer,
wherein said bottom flock layer comprises at least a trace amount of at least one ingredient of a release layer composition.

29. The fabric of claim 28, wherein said trace amount constitutes less than 1% by weight of the total weight of the fabric.

30. The fabric of claim 28, further comprising a support substrate releasably attached to the fabric via said release layer.

31. The fabric of claim 28, further comprising at least one preformed object incorporated therein.
